(19) United States
(12) Patent Application Publication
(10) Pub. No.: US 2026/0023057 A1
(43) Pub. Date: Jan. 22, 2026

(54) FLOW-PATH STATE OUTPUT DEVICE

(71) Applicant: SHIMADZU CORPORATION, Kyoto-shi (JP)

(72) Inventors: Satoshi SHIMIZU, Kyoto-shi (JP); Daisuke MORITA, Kyoto-shi (JP)

(21) Appl. No.: 19/121,065

(22) PCT Filed: Oct. 6, 2023
(86) PCT No.: PCT/JP2023/036580

§ 371 Date: Apr. 14, 2025

(30) Foreign Application Priority Data
Oct. 14, 2022 (JP) 2022-165652

(51) Int. Cl. G01N 30/86; G01N 30/02; G01N 30/88

(52) U.S. Cl. CPC G01N 30/8651; G01N 30/88; G01N 2030/027; G01N 2030/8809

(57) ABSTRACT

A computer that is a flow-path state output device of one embodiment is connected to a liquid chromatograph, and acquires a result of an analysis process executed in the liquid chromatograph. The computer includes a feature acquirer and a state outputter. The feature acquirer measures, using an analysis device, a sample containing a known component, and acquires a feature based on a measurement result. The state outputter, based on the feature, outputs a flow-path state of the liquid chromatograph to a display.

### TECHNICAL FIELD

The present invention relates to a device that outputs a flow-path state of an analysis device.

### BACKGROUND ART

A liquid chromatograph includes a liquid sending system that sends, at a set flow rate, a solvent serving as a mobile phase. The pressure at which the solvent is sent may fluctuate due to entry of fine bubbles into the liquid sending system. For example, in the below-mentioned Patent Document 1, the fluctuation range of the pressure at which a solvent is sent is calculated. In a case in which the fluctuation range exceeds a reference value, a liquid sending failure is detected.

### PATENT DOCUMENT 1

WO 2020/183774 A1

### SUMMARY OF INVENTION

### Technical Problem

In a case in which air bubbles enter the liquid sending system, the liquid sending pressure rapidly fluctuates. Thus, it is possible to detect a liquid sending failure by acquiring the fluctuation range as described above. However, although a change in liquid sending pressure is not so large, an abnormality that affects an analysis result may have occurred in the flow path in the liquid chromatograph. With the above-mentioned method of acquiring the fluctuation range of the liquid sending pressure, it is difficult to detect such an abnormality.

An object of the present invention is to identify a flow-path state of an analysis device which is difficult to be detected based on a fluctuation of a liquid sending pressure.

### Solution to Problem

A flow-path state output device according to one aspect of the present invention includes a feature acquirer that measures, using an analysis device, a sample containing a known component, and acquires a feature based on a measurement result, and a state outputter that outputs, to a display device, information representing a flow-path state of the analysis device based on the feature.

### Advantageous Effects of Invention

With the present invention, it is possible to identify a flow-path state of an analysis device which is difficult to be detected based on a fluctuation of a liquid sending pressure.

### BRIEF DESCRIPTION OF THE DRAWINGS

FIG. 1 is a diagram of the configuration of a computer (flow-path state output device) according to the present embodiment.

FIG. 2 is a diagram showing the functional configuration of the computer (flow-path state output device).

FIG. 3 is a diagram showing the configuration of a dedicated flow path for acquiring a flow-path state included in a liquid chromatograph.

FIG. 4 is a flowchart showing state acquisition and a method of acquiring a flow-path state and a method of outputting the flow-path state.

FIG. 5 is a diagram showing flow-path state information to be displayed on a display.

FIG. 6 is a diagram showing flow-path state information to be displayed on the display.

FIG. 7 is a diagram showing flow-path state information to be displayed on the display.

FIG. 8 is a diagram showing flow-path state information to be displayed on the display.

FIG. 9 is a diagram showing flow-path state information according to a modified example to be displayed on the display.

FIG. 10 is a diagram showing flow-path state information according to a modified example to be displayed on the display.

FIG. 11 is a diagram showing flow-path state information according to a modified example to be displayed on the display.

FIG. 12 is a diagram showing flow-path state information according to a modified example to be displayed on the display.

### DESCRIPTION OF EMBODIMENTS

A flow-path state output device according to embodiments of the present invention will now be described with reference to the attached drawings.

### (1) Overall Configuration of Analysis System

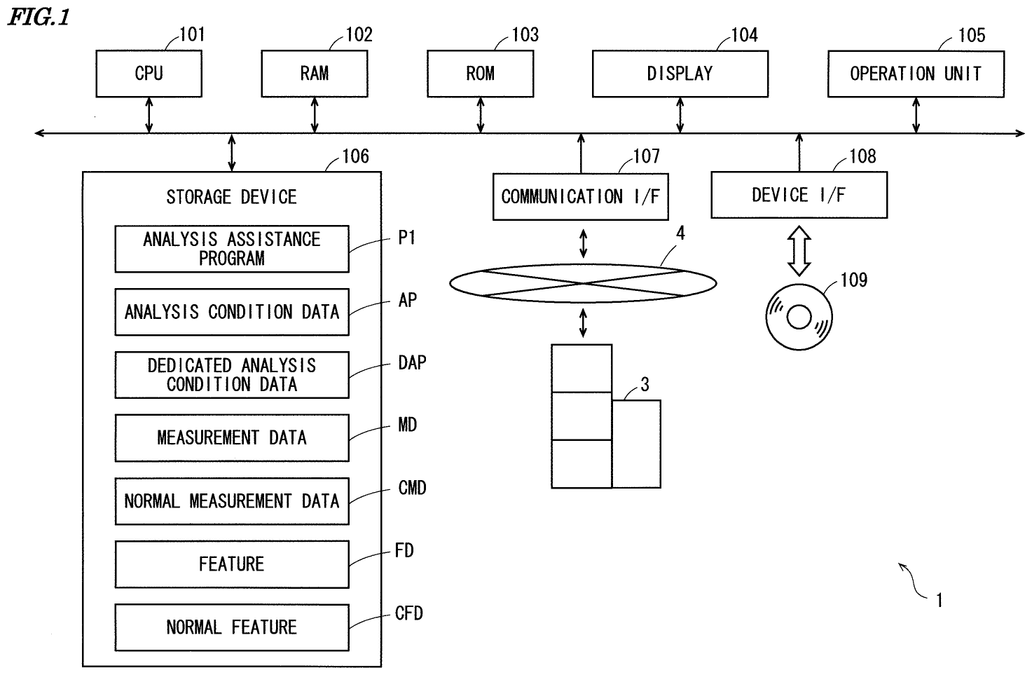

FIG. 1 is a diagram of the configuration of a computer 1 which is a flow-path state output device according to the present embodiment. The computer 1 is connected to a liquid chromatograph 3 through a network 4 such as a LAN (Local Area Network).

The computer 1 has a function of setting an analysis condition in the liquid chromatograph 3, a function of acquiring a result of measurement in the liquid chromatograph 3 and analyzing the result of measurement, and so on. A program for controlling the liquid chromatograph 3 is installed in the computer 1.

The liquid chromatograph 3 includes a pump unit, an autosampler unit, a column oven unit (including a column unit), a detector unit and so on. The liquid chromatograph 3 also includes a system controller. The system controller controls the liquid chromatograph 3 in accordance with a control instruction received from the computer 1 through the network 4. The system controller transmits the data of a result of measurement of the liquid chromatograph 3 to the computer 1 through the network 4.

### (2) Configuration of Computer (Flow-Path State Output Device)

In the present embodiment, a personal computer is utilized as the computer 1. As shown in FIG. 1, the computer 1 includes a CPU (Central Processing Unit) 101, a RAM (Random Access Memory) 102, a ROM (Read Only Memory) 103, a display 104, an operation unit 105, a storage device 106, a communication interface 107 and a device interface 108.

The CPU 101 controls the computer 1. The RAM 102 is used as a work area for execution of a program by the CPU 101. A control program and the like are stored in the ROM 103. The display 104 is a liquid crystal display, for example. The operation unit 105 is a device that receives a user operation, and includes a keyboard, a mouse and so on. The display 104 may be constituted by a touch panel display, and the display 104 may have a function of serving as the operation unit 105. The display 104 is an example of a display device of the present invention. The storage device 106 is a device that stores various programs and data. The storage device 106 is a hard disc, for example. The communication interface 107 is an interface that communicates with another computer and another device. The communication interface 107 is connected to the network 4. The device interface 108 is an interface for accessing various external devices. The CPU 101 can access a recording medium 109 through an external device connected to the device interface 108.

The storage device 106 stores an analysis assistance program P1, analysis condition data AP, dedicated analysis condition data DAP, measurement data MD, normal measurement data CMD, a feature FD and a normal feature CFD. The analysis assistance program P1 is a program for controlling the liquid chromatograph 3. The analysis assistance program P1 has a function of setting an analysis condition with respect to the liquid chromatograph 3, a function of acquiring a measurement result from the liquid chromatograph 3 and analyzing the measurement result, etc.

The analysis condition data AP is the data describing an analysis method (analysis condition) to be set in the liquid chromatograph 3 and includes a plurality of analysis parameters. The dedicated analysis condition data DAP is the data describing a dedicated analysis method for acquiring a flow-path state of the liquid chromatograph 3. The measurement data MD is the data of a measurement result acquired from the liquid chromatograph 3. The normal measurement data CMD is the data, in the measurement data MD, of a measurement result that is acquired when the liquid chromatograph 3 is normally working. The feature FD is the data representing the characteristic of a measurement result that is obtained based on the measurement data MD. The feature FD is the data representing measurement quality such as a retention time or a tailing amount. The normal feature CFD is the data representing the characteristic of a measurement result obtained based on the normal measurement data CMD. That is, the normal feature CFD is the data representing a feature of the measurement result that is acquired when the liquid chromatograph 3 is normally working.

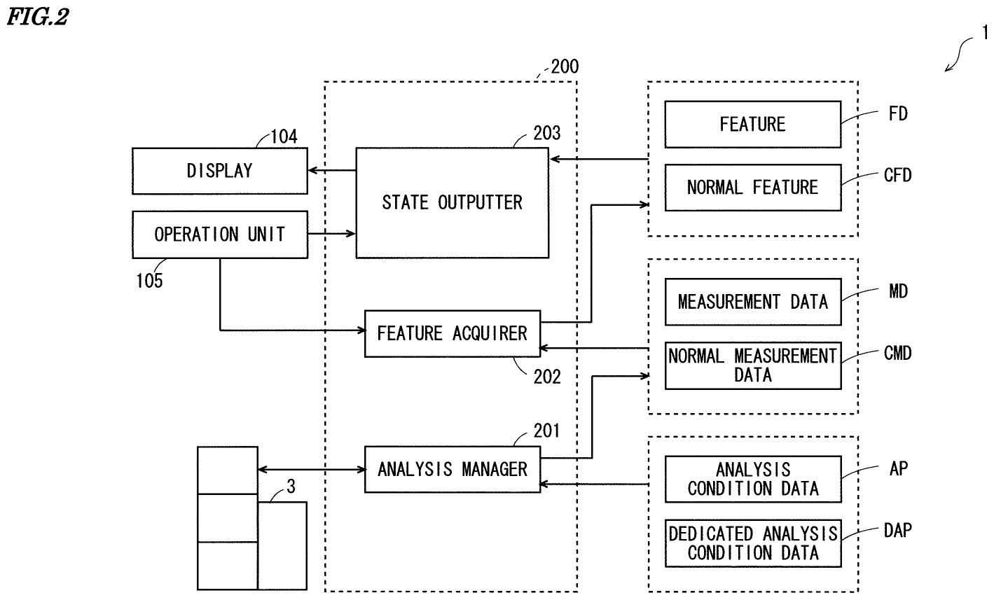

FIG. 2 is a block diagram showing the functions of the computer 1. The controller 200 is a function implemented when the CPU 101 executes the analysis assistance program P1 using the RAM 102 as a work area. The controller 200 includes an analysis manager 201, a feature acquirer 202 and a state outputter 203.

The analysis manager 201 controls the liquid chromatograph 3. In response to receiving a user instruction for setting analysis condition data AP and starting an analysis process, the analysis manager 201 provides an instruction for executing the analysis process to the liquid chromatograph 3. The analysis manager 201 also acquires measurement data MD from the liquid chromatograph 3.

Based on the measurement data MD representing a result of measurement in the liquid chromatograph 3, the feature acquirer 202 calculates a feature FD. The feature acquirer 202 calculates, as a feature FD, a retention time, a tailing time or the like. Further, based on normal measurement data CMD, the feature acquirer 202 calculates a normal feature CFD.

Based on a feature FD, the state outputter 203 displays information representing a flow-path state of the liquid chromatograph 3 (hereinafter referred to as flow-path state information) on the display 104. A “flow-path state” in the present invention represents a state of the flow path connecting the respective units included in the liquid chromatograph 3 to one another. For example, the state of the flow path connecting the pump unit and the autosampler unit to each other, the state of the flow path in the pump unit or the autosampler unit, the state of the flow path connecting the autosampler unit and the column unit to each other, the state of the flow path connecting the column unit and the detector unit to each other, and the like are included.

### (3) Configuration of Liquid Chromatograph 3 for Acquiring Flow-Path State

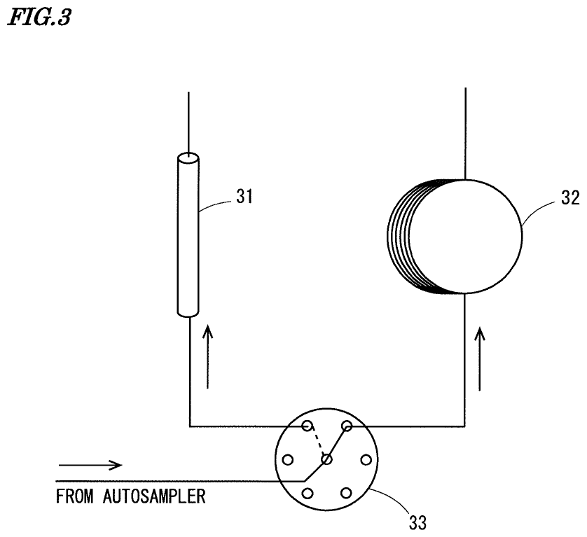

FIG. 3 is a diagram showing the configuration of a dedicated flow path, included in the liquid chromatograph 3, for acquiring a flow-path state. The liquid chromatograph 3 includes a resistance pipe 32 that is connected to the flow path, instead of a column 31 for separating a sample, in a switchable manner. With switching control of a switching valve 33, a solvent (mobile phase) supplied from the autosampler is alternatively sent to the column 31 or the resistance pipe 32. The solvent that has flowed through the column 31 or the resistance pipe 32 is supplied to a detector included in the liquid chromatograph 3.

In the present embodiment, in a case in which a flow-path state of the liquid chromatograph 3 is acquired, the switching valve 33 is switched such that a solvent supplied from the autosampler flows through the resistance pipe 32. Thus, in a case in which a flow-path state is acquired, a solvent is prevented from flowing through the column 31. Therefore, it is possible to acquire the flow-path state while eliminating influence of deterioration of the column 31 or the like.

### (4) Method of Acquiring Flow-Path State and Method of Outputting Flow-Path State

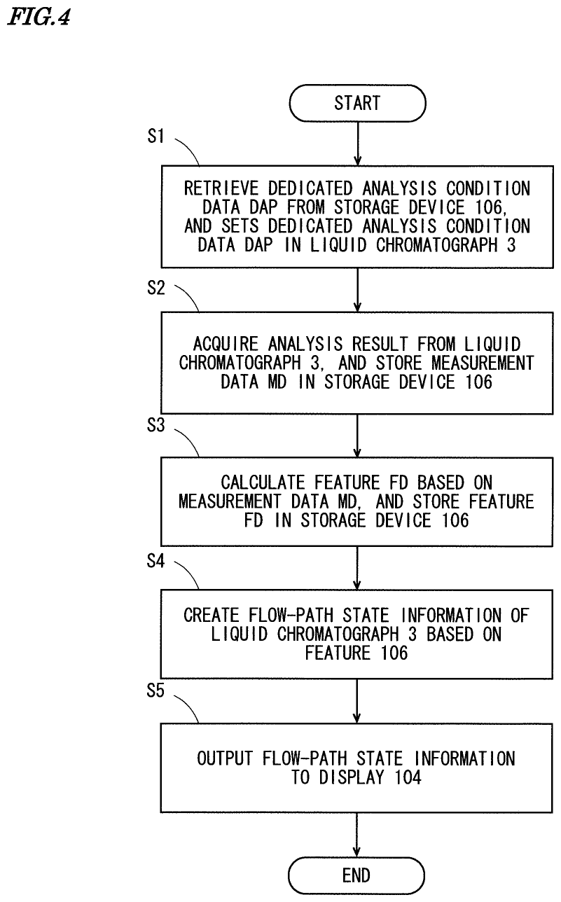

Next, a method of acquiring a flow-path state and a method of outputting a flow-path state to be executed in the computer 1 according to the present embodiment will be described. FIG. 4 is a flowchart showing the method of acquiring a flow-path state and the method of outputting a flow-path state according to the present embodiment. In the step S1, the analysis manager 201 retrieves dedicated analysis condition data DAP from the storage device 106 and sets the dedicated analysis condition data DAP in the liquid chromatograph 3. Specifically, the analysis manager 201 sets the analysis condition data DAP in the system controller of the liquid chromatograph 3. Thus, in the liquid chromatograph 3, an analysis process is executed based on the set dedicated analysis condition data DAP. In the dedicated analysis condition data DAP of the present embodiment, a standard sample such as caffeine is designated as a sample, and the standard sample is used for the analysis process for acquisition of a flow-path state. That is, the sample containing a known component is used for the analysis process for acquisition of a flow-path state. Further, when the analysis process is executed based on the dedicated analysis condition data DAP, the switching valve 33 shown in FIG. 3 is automatically switched, and the resistance pipe 32 is incorporated in the liquid chromatograph 3 instead of the column 31.

Next, in the step S2, the analysis manager 201 acquires, from the liquid chromatograph 3, measurement data MD. The analysis manager 201 stores, in the storage device 106, the acquired measurement data MD. The measurement data MD is a measurement result that is obtained based on the dedicated analysis condition data DAP. The measurement data MD is multidimensional data acquired by a multidimensional detector included in the liquid chromatograph 3. Here, the measurement data MD is three-dimensional data having a retention-time direction, a spectral direction (frequency direction) and an intensity as elements. For example, the measurement data MD is the data acquired in a liquid chromatograph 3 including a PDA detector (photodiode array detector).

Further, prior to the process of acquiring a flow-path state based on the flowchart of FIG. 4, normal measurement data CMD is acquired. Specifically, under the circumstance in which the liquid chromatograph 3 is working normally, the step S1 and the step S2 are performed, and the normal measurement data CMD is acquired. For example, the normal measurement data CMD is acquired in an initial state such as immediately after installation of the liquid chromatograph 3. The normal measurement data CMD is stored in the storage device 106.

Next, in the step S3, the feature acquirer 202 retrieves the measurement data MD stored in the storage device 106 and calculates, based on the measurement data MD, a feature FD. The feature acquirer 202 stores, in the storage device 106, the calculated feature FD. The feature FD includes a retention time, a tailing time or a peak height, for example.

Further, prior to the process of acquiring a flow-path state based on the flowchart of FIG. 4, the feature acquirer 202 calculates, based on the normal measurement data CMD, a normal measurement data CMD. The normal feature CFD is stored in the storage device 106.

In order to correctly identify a flow-path state, the measurement data MD and the normal measurement data CMD are respectively acquired by a plurality of analysis processes. For example, the dedicated analysis condition data DAP describes that the analysis process is repeatedly executed multiple times based on a same analysis method. Then, based on a plurality of measurement data pieces MD and a plurality of normal measurement data pieces CMD, a plurality of features FD and a plurality of normal features CFD are calculated.

Next, in the step S4, the state outputter203 creates, based on the features FD, the flow-path state information of the liquid chromatograph 3. The flow-path state information is a graph for the features FD, for example. Alternatively, the flow-path state information is the determination result in regard to the flow-path state.

Next, in the step S5, the state outputter 203 outputs, to the display 104, the flow-path state information created in the step S4.

### (5) Flow-Path State Information

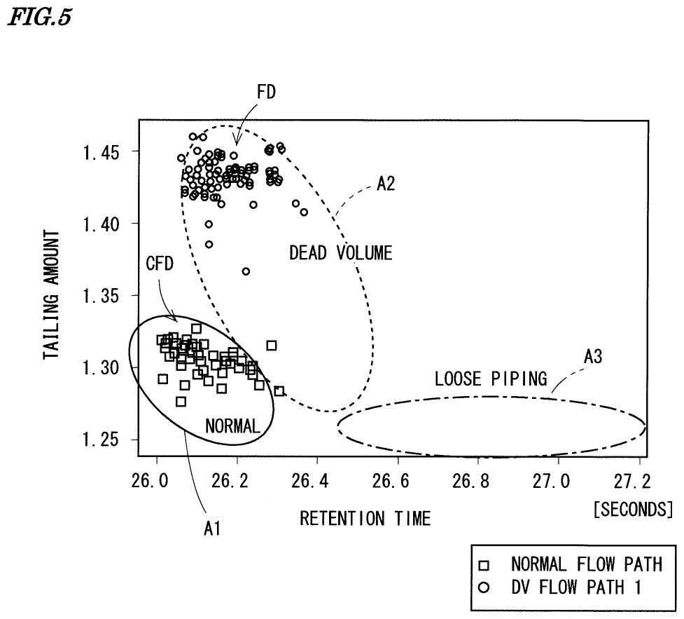

Next, the flow-path state information created by the state outputter 203 (the above-mentioned step S4) and displayed on the display 104 (the above-mentioned step S5) will be described. FIGS. 5 to 8 are diagrams showing examples of the flow-path state information.

FIGS. 5 to 8 are the graphs showing, as the flow-path state information, the relationship between two features, i.e., a retention time and a tailing amount. In FIGS. 5 to 8, the abscissa indicates the retention time (seconds), and the ordinate indicates the tailing amount. The tailing amount is a relative value on the basis of a peak width, with the peak width being set to 1 when tailing is not present. In FIGS. 5 to 8, symbols of outlined squares are the plotted points of the normal features CFD. In FIG. 5, outlined circles are the plotted points of the features FD obtained in the process of acquiring a state. A plurality of symbols are displayed in regard to both of the normal features CFD and the features FD in FIGS. 5 to 8. As described above, the plurality of symbols represent the results of the analysis process that is executed multiple times based on the dedicated analysis condition data DAP.

In FIGS. 5 to 8, an area A1 indicates the range of features in a normal state. An area A2 indicates the range of features with which a dead volume is assumed to be formed. An area A3 indicates the range of features with which loose piping is assumed to occur. In this example, curved frames showing the areas A1 to A3 are displayed as the flow-path state information, thereby facilitating identification of flow-path states by a user. However, the frames showing the areas A1 to A3 do not have to be displayed. Further, captions such as “NORMAL,” “DEAD VOLUME” and “LOOSE PIPING” are displayed in the vicinity of the areas A1 to A3 as the flow-path state information, thereby facilitating identification of flow-path states by the user. However, these captions do not have to be displayed.

In the example of FIG. 5, the features FD are distributed in the area A2. That is, the features FD are distributed in the area where the tailing amounts are large. By presenting this flow-path state information, the user can identify that a dead volume may be formed in the flow path of the liquid chromatograph 3. Even when the pressure at which a solvent is sent is measured, for example, it is difficult to detect formation of a dead volume in any of the pipes included in the liquid chromatograph 3. However, as shown in FIG. 5, by presenting the graph of the features FD, it is possible to suggest, to the user, that a dead volume may be formed.

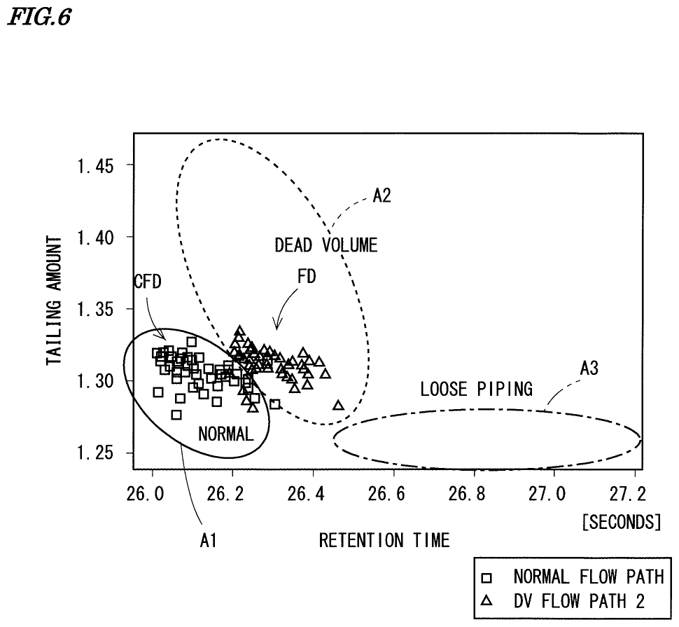

In FIG. 6, outlined triangles are the plotted points of the features FD obtained in the process of acquiring a state. Also in the example of FIG. 6, the features FD are distributed in the area A2. That is, the features FD are distributed in the area where the tailing amounts are large. By presenting this flow-path state information, the user can identify that a dead volume may be formed in the flow path of the liquid chromatograph 3. However, the tailing amounts of the features FD are small as compared to FIG. 5. Therefore, the user can identify relatively early that a dead volume may be formed.

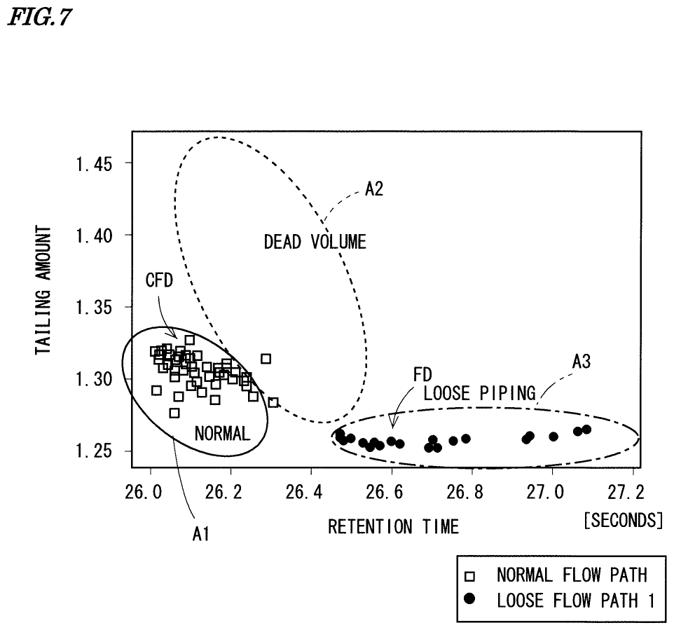

In FIG. 7, black circles are the plotted points of the features FD obtained in the process of acquiring a state. In the example of FIG. 7, the features FD are distributed in the area A3. That is, the features FD are distributed in the area where retention times are large. By presenting this flow-path state information, the user can identify that subtle loose piping may be present in the flow path of the liquid chromatograph 3.

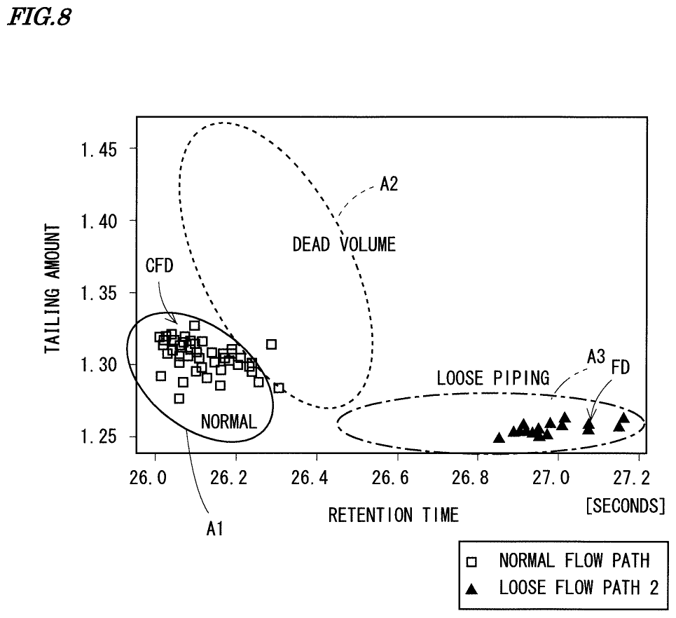

In FIG. 8, black triangles are the plotted points of the features FD obtained in the process of acquiring a state. Also in the example of FIG. 8, the features FD are distributed in the area A3. That is, the features FD are distributed in the area where retention times are large. By presenting this flow-path state information, the user can identify that subtle loose piping may be present in the flow path of the liquid chromatograph 3. Further, the retention times of the features FD are long as compared to FIG. 7. Therefore, the user can identify that loose piping is highly likely present.

As described above, with the computer 1 (flow-path state output device) in the present embodiment, it is possible to identify the flow-path state of the liquid chromatograph 3 which is difficult to be detected based on a fluctuation of a liquid sending pressure. For example, subtle loose piping causes a small reduction in pressure which is difficult to be detected. However, with the examples shown in FIGS. 7 and 8, a delay in retention time can be identified as subtle loose piping. Further, in a case in which a dead volume is formed in the pipe, it cannot be confirmed as a change in liquid sending pressure. However, with the examples shown in FIGS. 5 and 6, an increase in tailing amount can be identified as formation of a dead volume. According to the present embodiment, it is possible to identify a flow-path state that cannot be detected based on a pressure fluctuation. Therefore, the state of the liquid chromatograph 3 can be managed before an abnormality that greatly affects an analysis result occurs.

### (6) Modified Examples of Flow-path State Information

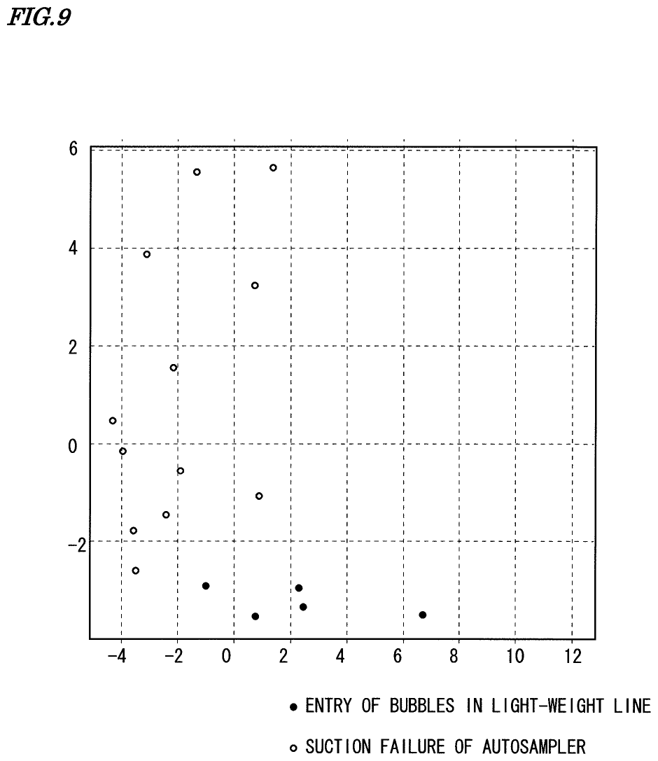

FIG. 9 shows a modified example of flow-path state information. An analysis process is executed multiple time (six times, for example) based on dedicated analysis condition data DAP, and a plurality of measurement data pieces MD are obtained. Then, based on the measurement data pieces MD obtained as results of the analysis process executed multiple times, a retention time, a peak area, a theoretical plate number, a tailing value and a pump pressure are calculated. Then, their features such as an average, a variance and a conversion rate are calculated. Then, these features are subjected to principal component analysis. FIG. 9 shows the result of the principal component analysis in regard to the features. In the diagram, the abscissa indicates a first principal component, and the ordinate indicates a second principal component. In the diagram, the outlined circles shows that the features may indicate suction failure of an autosampler. Further, black circles show that the features may indicate entry of bubbles into a light-weight line. Since both of entry of bubbles into a light-weight line and suction failure of an autosampler cause a peak area to be significantly small, it is difficult to specify the cause only by observing a peak area. However, by presenting the flow-path state information shown in FIG. 9, the user can determine the cause of an abnormality.

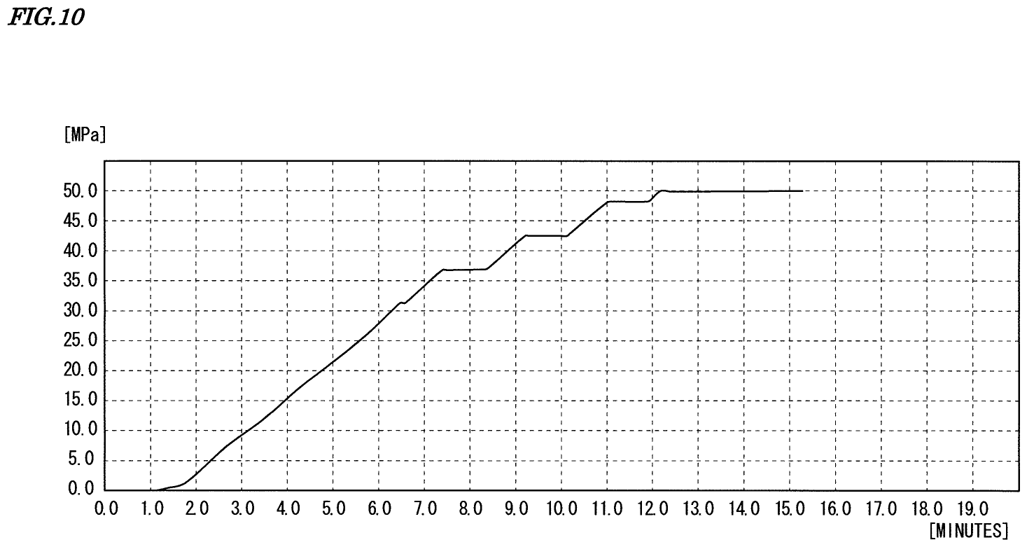

FIG. 10 shows another modified example of flow-path state information. In the above-mentioned embodiment, the resistance pipe 32 is utilized when the analysis process is executed to acquire a flow-path state. Thus, the influence of the column 31 is eliminated, and a flow-path state is acquired. In another example, when a flow-path state is acquired, a pipe having a sealed flow path may be used. FIG. 10 is a graph showing the transition of a pump pressure when a sealed pipe is used. In the diagram, the abscissa indicates time (minutes), and the ordinate indicates a pump pressure (MPa). When the pump deteriorates, a period of time until the pump pressure reaches a specific pressure increases. Thus, the user can identify a flow-path state. In this example, the sealing pipe is used as the dedicated configuration for acquiring a flow-path state. However, in another example, a feature may be acquired using a drain flow-path.

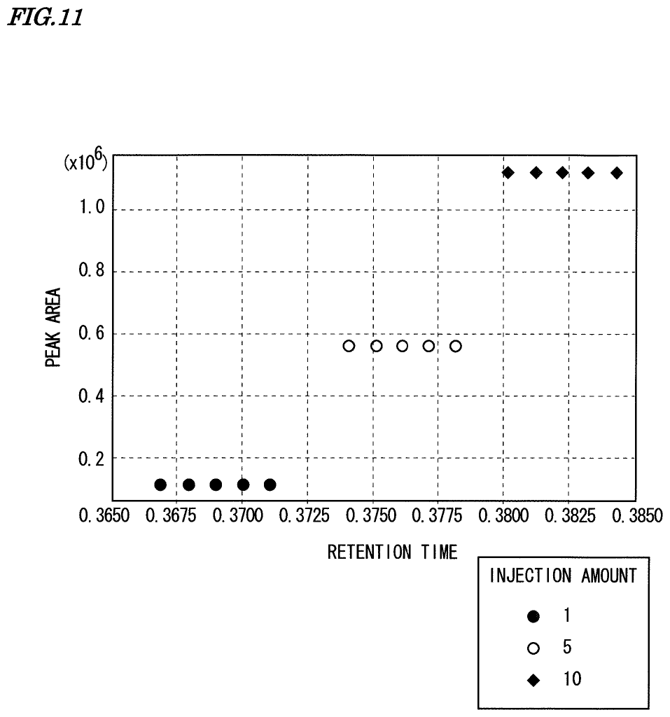

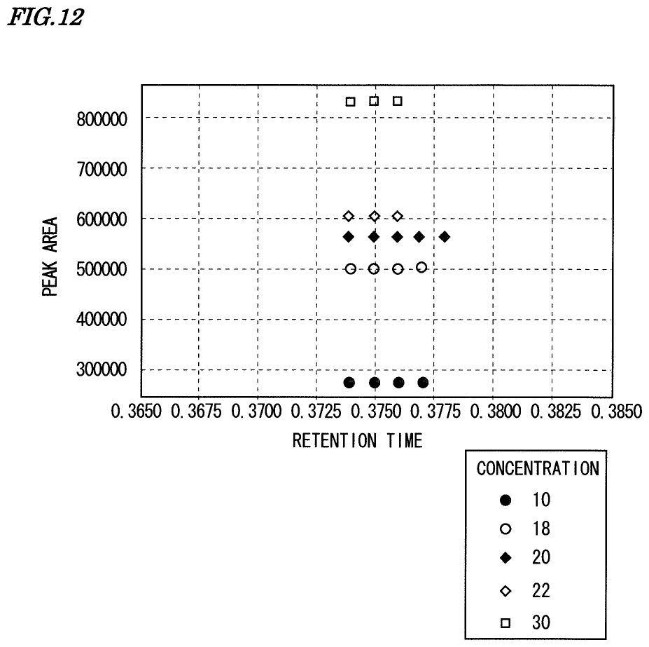

FIGS. 11 and 12 show another modified examples of flow-path state information. In each of FIGS. 11 and 12, the abscissa indicates a retention time, and the ordinate indicates a peak area. For example, in a case in which an amount of sample to be injected in the analysis process fluctuates, a retention time and a peak area change at the same time. FIG. 11 shows an example of the flow-path state information in a case in which an amount of sample to be injected fluctuates. In contrast, in a case in which a sample is not sufficiently diluted, only a peak area changes. FIG. 12 shows an example of the flow-path state information in a case in which a sample is not sufficiently diluted. Thus, the user can identify, as a flow-path state, that an amount of sample to be injected may be changed or that a sample may not be sufficiently diluted. In a case in which a flow-path state is acquired using an actual sample as a sample instead of a standard sample such as caffeine, the flow-path state information pieces shown in FIGS. 11 and 12 are valid.

### (7) Another Modified Example 1

In each of the examples of the flow-path state information shown in FIGS. 5 to 8, the graph for comparing a feature FD with a normal feature CFD is displayed. However, the display of a normal feature CFD is not essential, and only a feature FD may be displayed in a graph. Alternatively, based on a feature FD, the determination result of a flow-path state may be included in flow-path state information. The state outputter 203 may output a determination result by comparing a feature FD with a predetermined threshold value. Alternatively, the state outputter 203 may output a determination result by comparing a feature FD with a normal feature CFD. For example, in each of FIGS. 5 and 6, the message “Dead volume may be formed” may be displayed as a determination result in addition to the graph indicating a feature FD. Further, in each of FIGS. 7 and 8, the message “Loose piping may be present” may be displayed as a determination result. In a case in which a feature FD is in a normal range, the message “Normal” may be displayed. Alternatively, only a determination result may be displayed without a graph.

### (8) Another Modified Example 2

A result of analysis by the liquid chromatograph 3 may vary from day to day due to a difference in environment such as a temperature and a humidity on the day of an analysis. As such, two types of dedicated analysis condition data pieces DAP may be prepared, and a flow-path state may be presented or determined based on the ratio of two features FD obtained based on the two types of measurement results. Further, two normal features CFD may be acquired based on the two types of the dedicated analysis condition data pieces DAP, and the ratio of the two normal features CFD may be used as a reference for comparison with the ratio of the two features FD. A plurality of types of features FD may be calculated using three or more than three types of dedicated analysis condition data pieces DAP, and their ratios may be utilized.

### (9) Other Embodiments

In the above-mentioned embodiment, the liquid chromatograph 3 serves as an analysis device of the present invention, by way of example. The present invention can also be applied to a gas chromatograph. Further, in the above-mentioned embodiment, the computer 1 serving as the flow-path state output device of the present embodiment is connected to the liquid chromatograph 3 serving as an analysis device through the network 4, by way of example. In another embodiment, the computer 1 may be built in an analysis device.

In the above-mentioned embodiment, the analysis assistance program P1 is stored in the storage device 106, by way of example. In another embodiment, the analysis assistance program P1 may be stored in the recording medium 109 to be provided. The CPU 101 may access the recording medium 109 through the device interface 108 and may store, in the storage device 106 or the ROM 103, the analysis assistance program P1 stored in the recording medium 109. Alternatively, the CPU 101 may access the recording medium 109 through the device interface 108 and execute the analysis assistance program P1 stored in the recording medium 109. Alternatively, in a case in which the analysis assistance program P1 is stored in a sever on a network, the CPU 101 may download the analysis assistance program P1 through the communication interface 107.

### (10) Aspects

It will be appreciated by those skilled in the art that the exemplary embodiments described above are illustrative of the following aspects.

(Item 1) A flow-path state output device according to one aspect includes a feature acquirer that measures, using an analysis device, a sample containing a known component, and acquires a feature based on a measurement result, and a state outputter that outputs, to a display device, information representing a flow-path state of the analysis device based on the feature.

It is possible to identify the flow-path state of the analysis device which is difficult to be detected based on a fluctuation of a liquid sending pressure.

(Item 2) The flow-path state output device according to item 1, wherein the analysis device may include a chromatograph, and the feature may include a retention time and/or a tailing amount.

It is possible to identify the flow-path state of the analysis device based on the retention time and the tailing amount.

(Item 3) The flow-path state output device according to item 2, wherein the chromatograph may have a pump unit, an autosampler unit, a column oven unit and a detector unit, and a flow-path state of the analysis device may relate to a flow path that fluidly connects two units to each other, with the two units being among the pump unit, the autosampler unit, the column oven unit, the detector unit and other configuration units of the chromatograph.

It is possible to identify the flow-path state between respective units included in the chromatograph.

(Item 4) The flow-path state output device according to item 1, wherein the state outputter may output a graph showing the feature.

It is possible to visually present the flow-path state of the analysis device.

(Item 5) The flow-path state output device according to item 1, wherein the state outputter may output a determination result of the flow-path state.

It is possible to clearly present the flow-path state of the analysis device.

(Item 6) The flow-path state output device according to item 4, wherein the feature acquirer, when the flow-path state is normal, may acquire a normal feature obtained by an analysis process using the sample, and the state outputter may output a graph in which the feature is compared with the normal feature.

Because the normal feature and the feature are displayed for comparison, it is easy to identify the flow-path state.

(Item 7) The flow-path output device according to item 5, wherein the feature acquirer, when the flow-path state is normal, may acquire a normal feature obtained by an analysis process using the sample, and the state outputter may output the determination result by comparing the feature with the normal feature.

A highly reliably determination result is output.

(Item 8) The flow-path state output device according to item 1, wherein the feature acquirer may acquire the feature by utilizing, instead of a column of the analysis device, a dedicated flow path for acquiring the flow-path state.

It is possible to eliminate influence of the column to acquire the flow-path state.

(Item 9) The flow-path state output device according to item 1, wherein the feature acquirer may acquire the feature by utilizing a dedicated analysis method for acquiring the flow-path state.

It facilitates identification of the flow-path state by utilization of the dedicated analysis method suitable for acquisition of the flow-path state.

(Item 10) The flow-path state output device according to item 9, wherein the feature acquirer may acquire the plurality of features by utilizing a plurality of types of the dedicated analysis methods, and the state outputter may output the flow-path state of the analysis device based on ratios in regard to the plurality of features.

It is possible to correctly identify the flow-path state by eliminating day-to-day variations.

1. A flow-path state output device comprising:
a feature acquirer that measures, using an analysis device, using a first analysis method and a second analysis method that are different from each other, a sample containing a known component, and acquires respective first feature and second feature based on respective a measurement results; and
a state outputter that outputs, to a display device, information representing a flow-path state of the analysis device based on the first feature and the second feature.

2. The flow-path state output device according to claim 1, wherein
the analysis device includes a chromatograph, and each of the first feature and the second feature includes a retention time and/or a tailing amount.

3. The flow-path state output device according to claim 2, wherein
the chromatograph has a pump unit, an autosampler unit, a column oven unit and a detector unit, and
a flow-path state of the analysis device relates to a flow path that fluidly connects two units to each other, with the two units being among the pump unit, the autosampler unit, the column oven unit, the detector unit and other configuration units of the chromatograph.

4. The flow-path state output device according to claim 1, wherein
the state outputter outputs a graph showing the first feature and the second feature.

5. The flow-path state output device according to claim 1, wherein the state outputter outputs a determination result of the flow-path state.

6-7. (canceled)

8. The flow-path state output device according to claim 1, wherein
the feature acquirer acquires the first feature and the second feature by utilizing, instead of a column of the analysis device, a dedicated flow path for acquiring the flow-path state.

9. The flow-path state output device according to claim 1, wherein
the feature acquirer acquires first feature and the second feature by utilizing a dedicated analysis method for acquiring the flow-path state.

10. The flow-path state output device according to claim 1, wherein
the state outputter outputs the flow-path state of the analysis device based on a ratio between the first feature and the second feature.

11. The flow-path state output device according to claim 8, wherein
the feature acquirer, when the flow-path state is normal, acquires a first normal feature and a second normal feature, with the first normal feature and the second normal feature being acquired in an analysis process in which the first analysis method and the second analysis method are used, and the state outputter outputs the flow-path state based on the ratio between the first feature and the second feature, with the ratio being compared with a ratio between the first normal feature and the second normal feature.
